(19) United States
(12) Patent Application Publication
(10) Pub. No.: US 2019/0121444 A1
(43) Pub. Date: Apr. 25, 2019

(54) KEYBOARD DEVICE

(71) Applicant: Primax Electronics Ltd., Taipei (TW)

(72) Inventor: BO-AN CHEN, Taipei (TW)

(21) Appl. No.: 15/865,593

(22) Filed: Jan. 9, 2018

(30) Foreign Application Priority Data
Oct. 20, 2017 (TW) 106136197

(51) Int. Cl. G06F 3/02; H01H 13/702; G06F 3/023

(52) U.S. Cl. CPC G06F 3/0202; G06F 3/023; H01H 13/702

(57) ABSTRACT

A keyboard device includes plural key structures, a membrane wiring board, a base plate and a groove. The plural key structures are connected with the base plate. The membrane wiring board is arranged between the keycaps of the plural key structures and the base plate. The membrane wiring board includes an upper film layer and a lower film layer. Each upper contact of the upper film layer and the corresponding lower contact of the lower film layer are separated from each other by a spacing interval and collectively defined as a membrane switch. The groove is arranged between the membrane wiring board and the base plate, or formed in the base plate. The groove is in communication with a lower film gas hole of the lower film layer.

### FIELD OF THE INVENTION

The present invention relates to an input device, and more particularly to a keyboard device.

### BACKGROUND OF THE INVENTION

Generally, the widely-used peripheral input device of a computer system includes for example a mouse device, a keyboard device, a trackball device, or the like. Via the keyboard device, characters or symbols can be inputted into the computer system directly. As a consequence, most users pay much attention to the keyboard devices.

Hereinafter, the structure and function of a conventional keyboard device will be described with reference to FIGS. 1 and 2. FIG. 1 is a schematic side view illustrating a conventional keyboard device. FIG. 2 is a schematic exploded view illustrating a portion of a membrane wiring board of the conventional keyboard device of FIG. 1. The conventional keyboard device 1 comprises plural key structures 12, a base plate 13 and a membrane wiring board 14. Each of the plural key structures 12 comprises a keycap 121, a scissors-type connecting element 122 and an elastic element 123. The scissors-type connecting element 122 is connected between the keycap 121 and the base plate 13. Moreover, the scissors-type connecting element 122 comprises a first frame 1221 and a second frame 1222. The second frame 1222 is pivotally coupled to the first frame 1221. Consequently, the first frame 1221 and the second frame 1222 can be swung relative to each other. The elastic element 123 is arranged between the keycap 121 and the membrane wiring board 14. Moreover, the elastic element 123 comprises a contacting part 1231.

The membrane wiring board 14 comprises an upper film layer 142, a lower film layer 141 and an intermediate film layer 143. The intermediate film layer 143 is arranged between the upper film layer 142 and the lower film layer 141. A first circuit pattern 1421 is formed on a bottom surface of the upper film layer 142. The first circuit pattern 1421 comprises plural upper contacts 14211 corresponding to the plural key structures 12. A second circuit pattern 1411 is formed on a top surface of the lower film layer 141. The second circuit pattern 1411 comprises plural lower contacts 14111 corresponding to the plural upper contacts 14211. In addition, the intermediate film layer 143 comprises plural perforations 1431 corresponding to the plural upper contacts 14211 and the plural lower contacts 14111. Each of the upper contacts 14211 and the corresponding lower contact 14111 are collectively defined as a membrane switch 144.

While the keycap 121 of any key structure 12 is depressed and moved downwardly relative to the base plate 13, the first frame 1221 and the second frame 1222 of the scissors-type connecting element 122 are switched from an open-scissors state to a stacked state. Moreover, as the keycap 121 is moved downwardly to compress the elastic element 123, the corresponding upper contact 14211 is contacted with and triggered by the contacting part 1231 of the elastic element 123. Consequently, the corresponding upper contact 14211 is penetrated through the corresponding perforation 1431 and contacted with the corresponding lower contact 14111. Under this circumstance, the corresponding membrane switch 144 is electrically conducted. When the keycap 121 of the key structure 12 is no longer depressed, the keycap 121 is moved upwardly relative to the base plate 13 in response to an elastic force of the elastic element 123. Meanwhile, the first frame 1221 and the second frame 1222 are switched from the stacked state to the open-scissors state again, and the keycap 121 is returned to its original position.

Generally, if the foreign liquid is introduced into the key structure, the membrane wiring board is possibly in a short-circuited state. For solving this problem, the membrane wiring board is designed to be a sealed structure with a waterproof function. Since the inner space of the sealed membrane wiring board contains gas, the inner gas is subjected to expansion or contraction in response to the temperature change. When the temperature increases, the volume of the inner gas expands. Since the distance between the upper contact and the corresponding lower contact increases, it is difficult to make electric conduction of the membrane switch. When the temperature decreases, the volume of the inner gas contracts. Since the distance between the upper contact and the corresponding lower contact decreases, it is easy to result in erroneous electric conduction of the membrane switch. For preventing from the erroneous operation of the membrane wiring board, the membrane wiring board is equipped with a gas-escaping channel to escape the gas from the membrane wiring board. Due to the arrangement of the gas-escaping channel, the membrane wiring board is not the sealed structure. Under this circumstance, the waterproof efficacy is deteriorated.

Consequently, the conventional keyboard device needs to be further improved.

### SUMMARY OF THE INVENTION

The present invention provides a keyboard device with a waterproof function. The electric conduction of the membrane switch of the keyboard device is not obviously influenced by the expansion or contraction of the inner gas.

In accordance with an aspect of the present invention, there is provided a keyboard device. The keyboard device includes a base plate, a membrane wiring board, plural key structures and a groove. The membrane wiring board is located over the base plate. The membrane wiring board includes an upper film layer and a lower film layer. The upper film layer includes a first circuit pattern. The lower film layer includes a second circuit pattern and at least one lower film gas hole. The first circuit pattern includes plural upper contacts. The second circuit pattern includes plural lower contacts. Each of the upper contacts and the corresponding lower contact are separated from each other by a spacing interval and collectively defined as a membrane switch. The plural key structures are located over the membrane wiring board. Each of the key structures is aligned with the corresponding membrane switch and includes a keycap and a connecting element. The connecting element is connected between the base plate and the keycap. The groove is arranged between the membrane wiring board and the base plate, or formed in the base plate. The groove is in communication with the at least one lower film gas hole.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional keyboard device;

FIG. 2 is a schematic exploded view illustrating a portion of a membrane wiring board of the conventional keyboard device of FIG. 1;

FIG. 3 is a schematic top view illustrating the outer appearance of a keyboard device according to a first embodiment of the present invention;

FIG. 4 is a schematic perspective view illustrating a portion of the keyboard device as shown in FIG. 3;

FIG. 5 is a schematic exploded view illustrating a portion of the keyboard device as shown in FIG. 3 and taken along a viewpoint;

FIG. 6 is a schematic exploded view illustrating a portion of the keyboard device as shown in FIG. 3 and taken along another viewpoint;

FIG. 7 is a schematic side view illustrating a portion of the membrane wiring board of the keyboard device as shown in FIG. 3;

FIG. 8 is a schematic cross-sectional view illustrating portions of the membrane wiring board and the base plate of the keyboard device as shown in FIG. 3;

FIG. 9 is a schematic cross-sectional view illustrating portions of a membrane wiring board and a base plate of a keyboard device according to a second embodiment of the present invention;

FIG. 10 is a schematic cross-sectional view illustrating portions of a membrane wiring board and a base plate of a keyboard device according to a third embodiment of the present invention;

FIG. 11 is a schematic cross-sectional view illustrating portions of a membrane wiring board and a base plate of a keyboard device according to a fourth embodiment of the present invention; and

FIG. 12 is a schematic cross-sectional view illustrating portions of a membrane wiring board and a base plate of a keyboard device according to a fifth embodiment of the present invention.

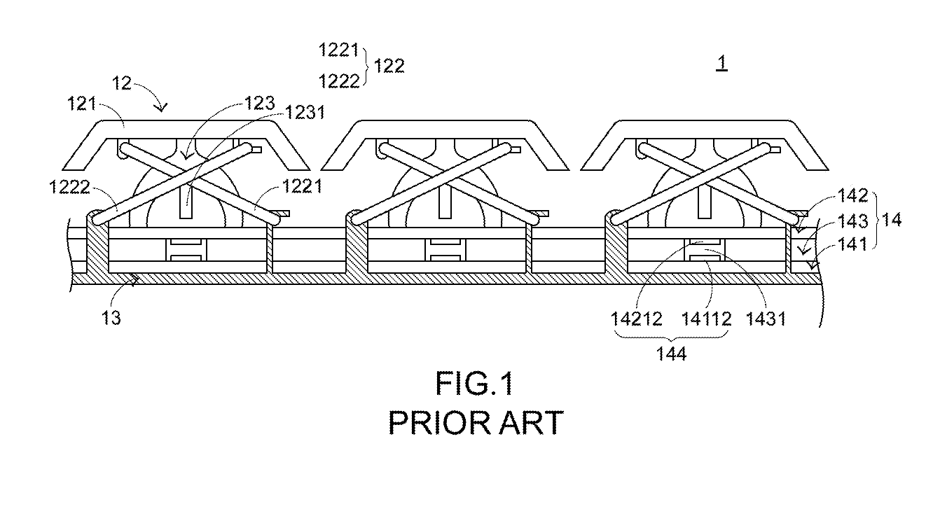

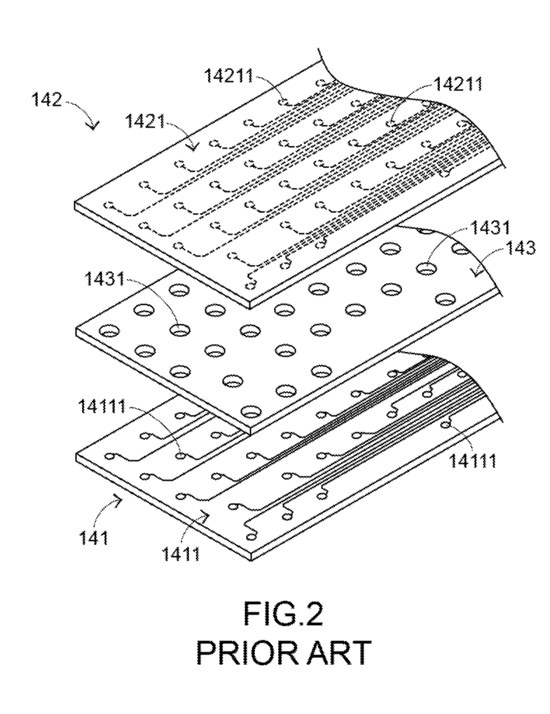

### DETAILED DESCRIPTION OF THE PREFERRED EMBODIMENT

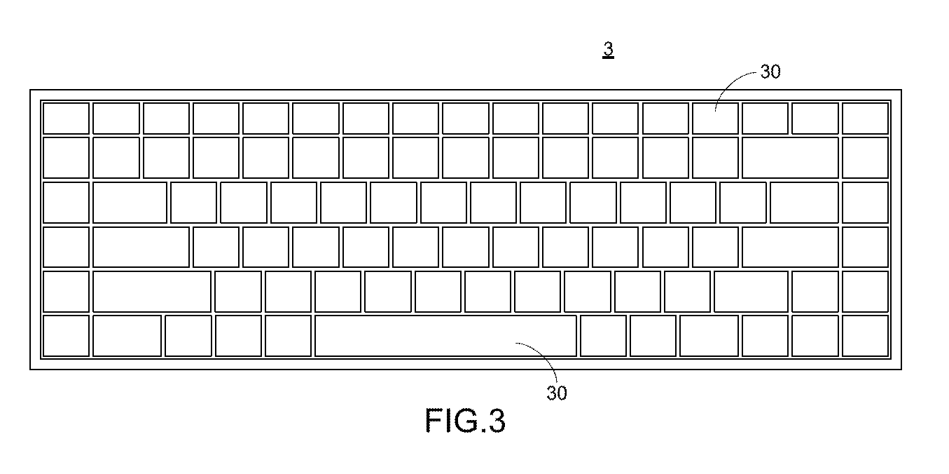

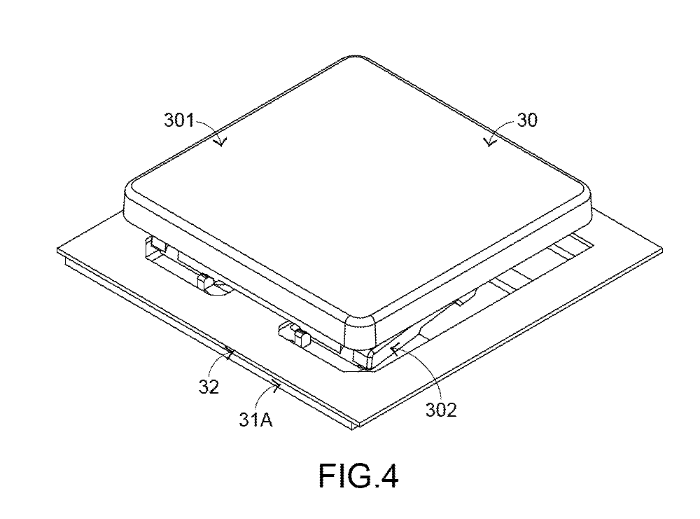

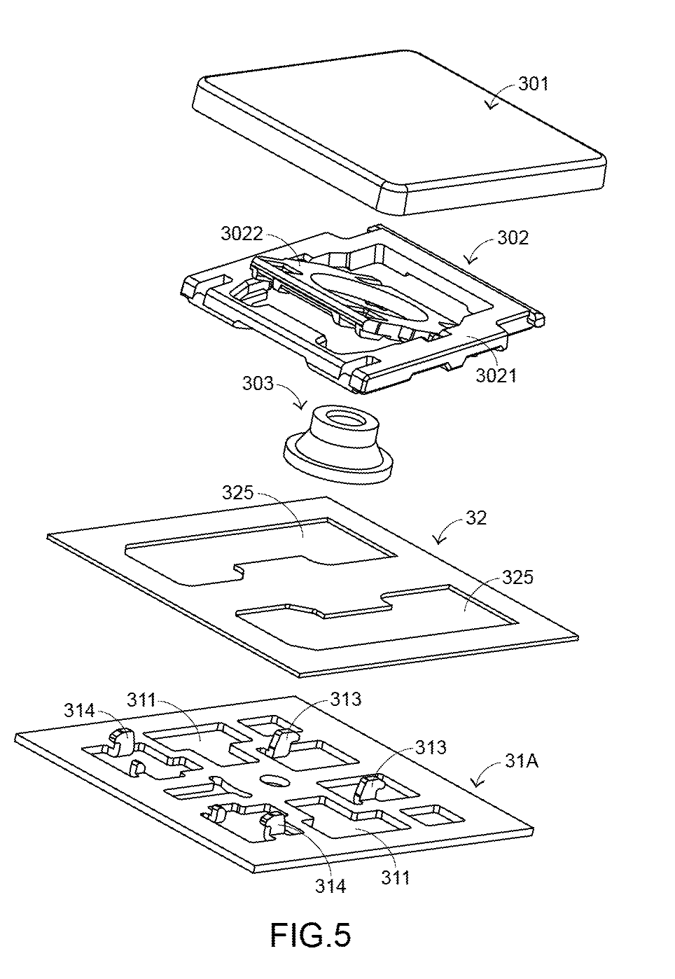

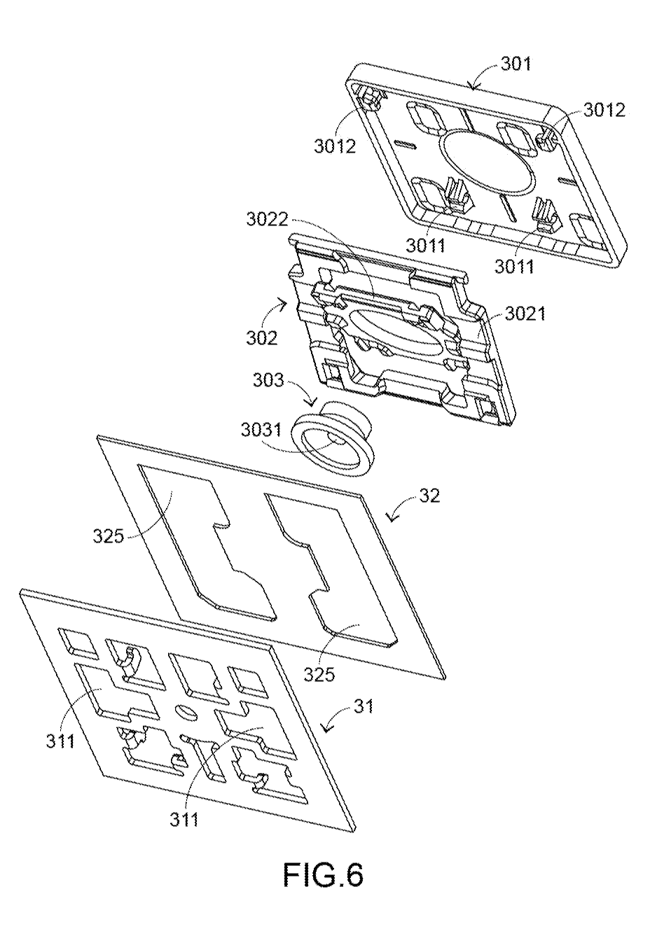

Please refer to FIGS. 3, 4, 5 and 6. FIG. 3 is a schematic top view illustrating the outer appearance of a keyboard device according to a first embodiment of the present invention. FIG. 4 is a schematic perspective view illustrating a portion of the keyboard device as shown in FIG. 3. FIG. 5 is a schematic exploded view illustrating a portion of the keyboard device as shown in FIG. 3 and taken along a viewpoint. FIG. 6 is a schematic exploded view illustrating a portion of the keyboard device as shown in FIG. 3 and taken along another viewpoint. For succinctness, only one key structure and associated components are shown in FIGS. 4, 5 and 6. The keyboard device 3 comprises plural key structures 30, a base plate 31A and a membrane wiring board 32. The membrane wiring board 32 is arranged between the plural key structures 30 and the base plate 31A. These key structures 30 are classified into some types, e.g., ordinary keys, numeric keys and function keys. When one of the key structures 30 is depressed by the user's finger, a corresponding key signal is generated to the computer, and thus the computer executes a function corresponding to the depressed key structure. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

Each of the key structures 30 comprises a keycap 301, a connecting element 302 and an elastic element 303. The connecting element 302 is connected between the keycap 301 and the base plate 31A. Through the connecting element 302, the keycap 301 is moved upwardly or downwardly relative to the base plate 31A. The elastic element 303 is arranged between the keycap 301 and the base plate 31A. Moreover, the elastic element 303 comprises a contacting part 3031. In this embodiment, the connecting element 302 is a scissors-type connecting element. Moreover, the connecting element 302 comprises a first frame 3021 and a second frame 3022. The second frame 3022 is pivotally coupled to the first frame 3021. Each keycap 301 comprises a connecting lock part 3011 and a connecting hook part 3012.

The base plate 31A comprises at least one base plate opening 311, a first hook 313 and a second hook 314. The at least one base plate opening 311 is located under the key structure 30. The first hook 313 and the second hook 314 are protruded upwardly and penetrated through circuit board openings 325 of the membrane wiring board 32. A first end of the first frame 3021 is connected with the connecting hook part 3012 of the keycap 301. A second end of the first frame 3021 is connected with the second hook 314 of the base plate 31A. A first end of the second frame 3022 is connected with the connecting lock part 3011 of the keycap 301. A second end of the second frame 3022 is connected with the first hook 313 of the base plate 31A. Due to the above design, the first frame 3021 and the second frame 3022 can be swung relative to each other. That is, the first frame 3021 and the second frame 3022 are selectively switched from an open-scissors state to a stacked state or switched from the stacked state to the open-scissors. The connecting relationships between the connecting element 302, the base plate 31A and the keycap 301 are presented herein for purpose of illustration and description only.

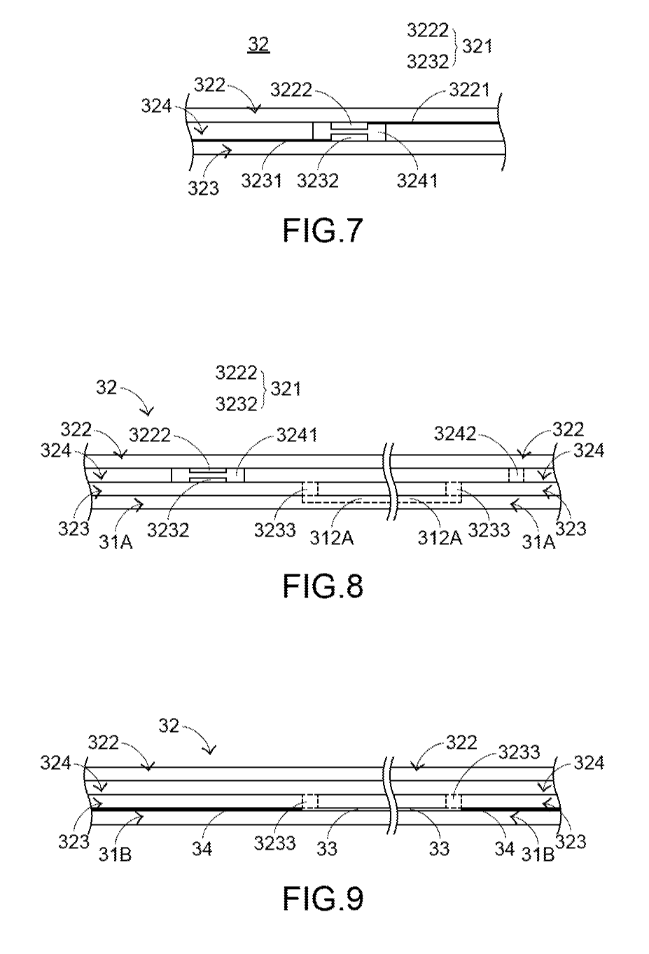

The membrane wiring board 32 comprises plural film layers, which are arranged in a stack form. FIG. 7 is a schematic side view illustrating a portion of the membrane wiring board of the keyboard device as shown in FIG. 3. In this embodiment, the membrane wiring board 32 comprises an upper film layer 322 and a lower film layer 323. A first circuit pattern 3221 is formed on a bottom surface of the upper film layer 322. The first circuit pattern 3221 comprises plural upper contacts 3222 corresponding to the plural key structures 30. A second circuit pattern 3231 is formed on a top surface of the lower film layer 323. The second circuit pattern 3231 comprises plural lower contacts 3232 corresponding to the plural upper contacts 3222. Each of the upper contacts 3222 and the corresponding lower contact 3232 are separated from each other by a spacing interval. Moreover, each of the upper contacts 3222 and the corresponding lower contact 3232 are collectively defined as a membrane switch 321. Moreover, for maintaining the spacing interval between each upper contact 3222 and the corresponding lower contact 3232, the membrane wiring board 32 further comprises an intermediate film layer 324. The intermediate film layer 324 is arranged between the upper film layer 322 and the lower film layer 323. In addition, the intermediate film layer 324 comprises plural perforations 3241 corresponding to the plural upper contacts 3222 and the plural lower contacts 3232. Preferably but not exclusively, at least one of the upper film layer 322, the lower film layer 323 and the intermediate film layer 324 is made of polycarbonate (PC), polyethylene terephthalate (PET), polymethylmethacrylate (PMMA), polyurethane (PU) or polyimide (PI).

While the keycap 301 of any key structure 30 is depressed and moved downwardly relative to the base plate 31A, the first frame 3021 and the second frame 3022 of the connecting element 302 are switched from the open-scissors state to the stacked state. Moreover, as the keycap 301 is moved downwardly to compress the elastic element 303, the corresponding upper contact 3222 is pushed and triggered by the contacting part 3031 of the elastic element 303. Consequently, the corresponding upper contact 3222 is contacted with the corresponding lower contact 3232 through the corresponding perforation 3241. In such way, the corresponding membrane switch 321 is electrically conducted, and the keyboard device 3 generates a corresponding key signal. When the keycap 301 of the key structure 30 is no longer depressed, the keycap 301 is moved upwardly relative to the base plate 31A in response to an elastic force of the elastic element 303. Meanwhile, the first frame 3021 and the second frame 3022 are switched from the stacked state to the open-scissors state again, and the keycap 301 is returned to its original position.

FIG. 8 is a schematic cross-sectional view illustrating portions of the membrane wiring board and the base plate of the keyboard device as shown in FIG. 3. For succinctness, only some components are shown in FIG. 8. In this embodiment, the lower film layer 323 of the membrane wiring board 32 further comprises lower film gas hole 3233, and the base plate 31A further comprises a groove 312A. The groove 312A is concavely formed in a top surface of the base plate 31A. In addition, the groove 312A is in communication with the lower film gas hole 3233. Consequently, the gas can flow in the region between the membrane wiring board 32 and the base plate 31A.

In another embodiment, the groove 312A and the corresponding lower film gas hole 3233 are arranged between two adjacent key structures 30. Moreover, the region between the membrane wiring board 32 and the base plate 31A is a sealed gas-flowing space. Preferably but not exclusively, the intermediate film layer 324 further comprises an intermediate film gas hole 3242 for allowing the gas to pass through.

As mentioned above, the volume of the gas within the membrane wiring board 32 is increased or decreased in response to the temperature change. Due to the design of the present invention, the air-flowing space is increased. Since the distance between each upper contact 3222 and the corresponding lower contact 3232 of the membrane wiring board 32 is not easily interfered by the volume of the inner gas, the electric connection of the membrane switch 321 is not adversely affected. Moreover, due to the design of the present invention, it is not necessary to install a gas-escaping channel in the membrane wiring board 32 to communicate with the surroundings. Since the foreign liquid is not introduced into the membrane wiring board 32, the membrane wiring board 32 is not in the short-circuited state. In other words, the keyboard device 3 of the present invention has a waterproof function.

It is noted that numerous modifications and alterations may be made while retaining the teachings of the invention. Some examples of the keyboard device will be described as follows.

FIG. 9 is a schematic cross-sectional view illustrating portions of a membrane wiring board and a base plate of a keyboard device according to a second embodiment of the present invention. For succinctness, only some components are shown in FIG. 9. The structures of the components of the keyboard device which are identical to those of the first embodiment are not redundantly described herein. In comparison with the first embodiment, the groove 33 of this embodiment is arranged between the membrane wiring board 32 and the base plate 31B. That is, unlike the first embodiment, the groove is not formed in the base plate. In an embodiment, the membrane wiring board 32 and the base plate 31B are combined together through an adhesive 34 (e.g., a waterproof adhesive). The region that is arranged between the membrane wiring board 32 and the base plate 31B but not coated with the adhesive 34 is defined as the groove 33. That is, the adhesive 34 is located at the periphery of the groove 33. Similarly, the groove 33 is in communication with the lower film gas hole 3233. Consequently, the gas can flow in the region between the membrane wiring board 32 and the base plate 31B.

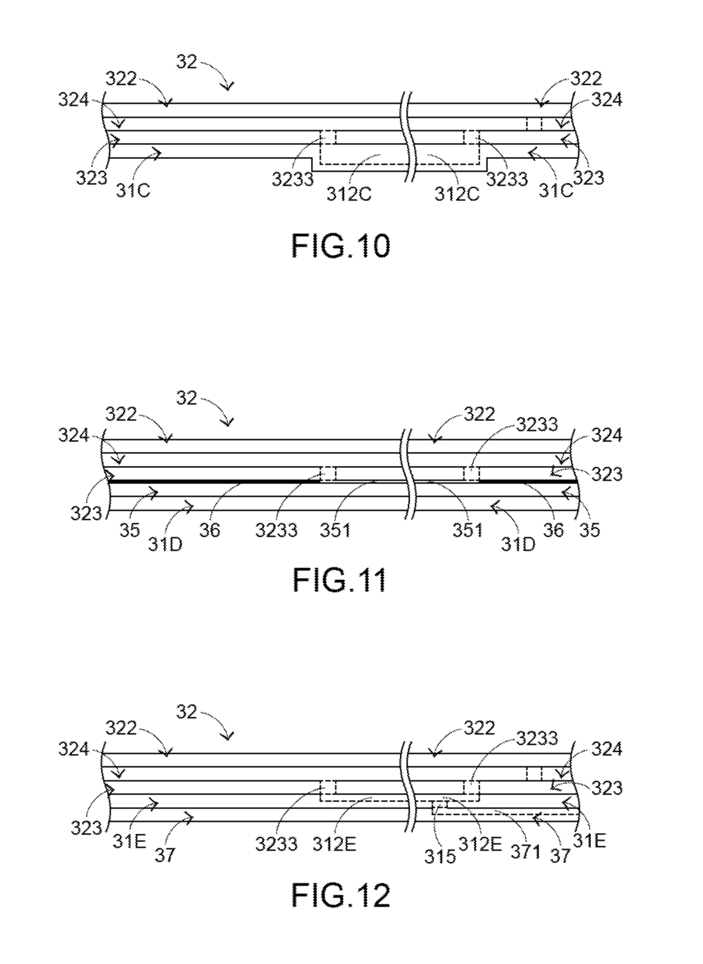

FIG. 10 is a schematic cross-sectional view illustrating portions of a membrane wiring board and a base plate of a keyboard device according to a third embodiment of the present invention. For succinctness, only some components are shown in FIG. 10. The structures of the components of the keyboard device which are identical to those of the first embodiment are not redundantly described herein. In comparison with the first embodiment, a portion of the base plate 31C is protruded downwardly. Consequently, the groove 312C is deeply and concavely formed in the top surface of the base plate 31C. The groove 312C is in communication with the lower film gas hole 3233. Consequently, the region between the membrane wiring board 32 and the base plate 31C for flowing the gas is increased.

FIG. 11 is a schematic cross-sectional view illustrating portions of a membrane wiring board and a base plate of a keyboard device according to a fourth embodiment of the present invention. For succinctness, only some components are shown in FIG. 11. The structures of the components of the keyboard device which are identical to those of the first embodiment are not redundantly described herein. In comparison with the first embodiment, the groove 351 of this embodiment is arranged between the membrane wiring board 32 and the base plate 31D. That is, unlike the first embodiment, the groove is not formed in the base plate. In this embodiment, the keyboard device further comprises a gas-escaping layer 35. The gas-escaping layer 35 is arranged between the membrane wiring board 32 and the base plate 31D. The gas-escaping layer 35 and the membrane wiring board 32 are combined together through an adhesive 36 (e.g., a waterproof adhesive). The region that is arranged between the gas-escaping layer 35 and the membrane wiring board 32 but not coated with the adhesive 36 is defined as the groove 351. That is, the adhesive 36 is located at the periphery of the groove 351. Similarly, the groove 351 is in communication with the lower film gas hole 3233. Consequently, the gas can flow in the region between the membrane wiring board 32 and the gas-escaping layer 35.

FIG. 12 is a schematic cross-sectional view illustrating portions of a membrane wiring board and a base plate of a keyboard device according to a fifth embodiment of the present invention. For succinctness, only some components are shown in FIG. 12. The structures of the components of the keyboard device which are identical to those of the first embodiment are not redundantly described herein. In comparison with the first embodiment, the keyboard device is a luminous keyboard. The keyboard device comprises a light-emitting element (not shown) and a backlight module 37. The backlight module 37 is located under the base plate 31E. The light beam emitted by the light-emitting element is transferred through the backlight module 37 and projected upwardly to the membrane wiring board 32. In this embodiment, the backlight module 37 further comprises a groove 371, and the base plate 31E comprises a groove 312E and a base plate gas hole 315. The base plate gas hole 315 is in communication with a first end of the groove 371. Consequently, the gas can flow in the region between the membrane wiring board 32 and the backlight module 37. In an embodiment, a second end of the groove 371 is closed. Alternatively, in another embodiment, the second end of the groove 371 is extended to a proper position and in communication with the surroundings. It is noted that the groove 371 is not restrictedly formed in the backlight module 37. For example, the groove 371 may be formed in another other appropriate structural component of the keyboard device according to the practical requirements.

From the above descriptions, the keyboard devices of the second embodiment, the third embodiment, the fourth embodiment and the fifth embodiment also have the similar benefits of the keyboard device of the first embodiment. That is, the volume of the gas within the membrane wiring board 32 is increased or decreased in response to the temperature change. Due to the design of the present invention, the air-flowing space is increased. Since the distance between each upper contact 3222 and the corresponding lower contact 3232 of the membrane wiring board 32 is not easily interfered by the volume of the inner gas, the electric connection of the membrane switch 321 is not adversely affected. Moreover, it is not necessary to install a gas-escaping channel in the membrane wiring board 32 to communicate with the surroundings. Since the foreign liquid is not introduced into the membrane wiring board 32, the membrane wiring board 32 is not in the short-circuited state. In other words, the keyboard device of the present invention in each of the second embodiment, the third embodiment, the fourth embodiment and the fifth embodiment has the waterproof function.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a base plate;
a membrane wiring board located over the base plate, and comprising an upper film layer and a lower film layer, wherein the upper film layer comprises a first circuit pattern, the lower film layer comprises a second circuit pattern and at least one lower film gas hole, the first circuit pattern comprises plural upper contacts, and the second circuit pattern comprises plural lower contacts, wherein each of the upper contacts and the corresponding lower contact are separated from each other by a spacing interval and collectively defined as a membrane switch;
plural key structures located over the membrane wiring board, wherein each of the key structures is aligned with the corresponding membrane switch and comprises a keycap and a connecting element, wherein the connecting element is connected between the base plate and the keycap; and
a groove arranged between the membrane wiring board and the base plate, or formed in the base plate, wherein the groove is in communication with the at least one lower film gas hole.

2. The keyboard device according to claim 1, wherein the groove is concavely formed in a top surface of the base plate.

3. The keyboard device according to claim 1, wherein the membrane wiring board and the base plate are combined together through an adhesive, and the adhesive is located at a periphery of the groove.

4. The keyboard device according to claim 1, wherein the keyboard device further comprises a gas-escaping layer between the membrane wiring board and the base plate, wherein the gas-escaping layer and the membrane wiring board are combined together through an adhesive, and the adhesive is located at a periphery of the groove.

5. The keyboard device according to claim 1, wherein the groove is arranged between two adjacent key structures of the plural key structures.

6. The keyboard device according to claim 1, wherein the keyboard device further comprises an additional groove and a structural component, wherein the additional groove is formed in the structural component, and the additional groove is in communication with the groove.

7. The keyboard device according to claim 6, wherein the structural component is a backlight module, and the backlight module is located under the base plate.

8. The keyboard device according to claim 6, wherein the base plate further comprises at least one base plate gas hole, and the at least one base plate gas hole is in communication with the groove and the additional groove.

9. The keyboard device according to claim 1, wherein the membrane wiring board further comprises an intermediate film layer between the upper film layer and the lower film layer, and each of the upper contacts and the corresponding lower contact are separated from each other by the spacing interval through the intermediate film layer, wherein the intermediate film layer comprises at least one intermediate film gas hole, and a gas is allowed to pass through the at least one intermediate film gas hole.

10. The keyboard device according to claim 1, wherein each of the plural key structures further comprises an elastic element, and the elastic element is arranged between the keycap and the membrane wiring board, wherein while the keycap is depressed, the elastic element is compressed to trigger the membrane switch, so that the corresponding upper contact and the corresponding lower contact are electrically conducted, wherein when the keycap is no longer depressed, the keycap is returned to an original position in response to an elastic force provided by the elastic element.
